(19) United States
(12) Patent Application Publication
(10) Pub. No.: US 2008/0008875 A1
(43) Pub. Date: Jan. 10, 2008

(54) Sterilized Micro Nano-Silver Film Having Nonpoisonous and the Process Thereof

(76) Inventor: Sang Oh Han, Ansan-si (KR)

Correspondence Address: IPLA P.A., 3580 WILSHIRE BLVD., 17TH FLOOR, LOS ANGELES, CA, 90010, US

(21) Appl. No.: 11/718,878

(22) PCT Filed: Nov. 11, 2004
(86) PCT No.: PCT/KR04/02921

§ 371 Date: May 8, 2007

(30) Foreign Application Priority Data
Nov. 8, 2004 (KR) 10-2004-0090271

(51) Int. Cl. C08J 5/18; B43K 19/00; C08K 3/00

(52) U.S. Cl. 428/335; 101/129

(57) ABSTRACT

A nontoxic micro anti-bacterial film coated with silver nano-particles and a method of manufacturing the same are disclosed. The method of manufacturing a non-toxic micro anti-bacterial film coated with silver nano-particles including the steps of: producing mixed/combined powers as anti-bacterial powders, thermosensitive or photosensitive ink capsule powers, and fragrant capsule powders, and silver nano powder are combined with an additive; producing solid powders as 20-50 weight % of the mixed/combined powders, and 50-80 weight % of olefin, acrylic or urethane binder are mixed and then disperse; producing a paste type of print ink as 30 weight % of the solid powders and 70 weight % of solvent are mixed; and printing the print ink on a thin film made of olefin resin, acrylic resin, and urethane resin, using a silk screen printing method, printing a predetermined design thereon. The designs of the non-toxic micro anti-bacterial film can be pressed and transferred to the stationery products or the necessaries of life. Therefore, users can obtain joy and interest from the products as designs are changed according to temperature change. Also, the non-toxic micro anti-bacterial film exhales fragrance and has anti-bacterial operation.

### TECHNICAL FIELD

The present invention relates to a nontoxic micro anti-bacterial film coated with silver nano-particles, which is manufactured such that mixed/combined powers composed of anti-bacterial powders, thermosensitive or photosensitive ink capsule powers and fragrant capsule powders, as main material, are combined with a binder and then disperse to form solid powders, the solid powers are mixed with solvent to produce a paste type of print ink, and the pint ink is printed on a thin film made of olefin group resin, acrylic group resin, and urethane group resin, using a silk screen printing method, printing a predetermined design thereon. Also, the present invention relates to a method of manufacturing the nontoxic micro anti-bacterial film coated with silver nano-particles.

### BACKGROUND ART

With development of industries, size of cities is enlarged, such that pollution of environments is serious in the cities. Therefore, citizens have been exposed to such noxious environments. Recently, the citizens have importantly thought their health such that a word well-being is popular. The fields of well-being are widely used in food culture and housing culture as well as the necessaries of life.

As such, Korean Patent Publication No. 10-2001-0077332 discloses an anti-bacterial film including natural anti-bacterial material. The anti-bacterial film is manufactured such that a mater batch of polyolefin resin, which is used for a wrapper for food, is mixed with vegetable seed extract, thereby enhancing anti-bacterial characteristic to improve food storage and decreases decay speed of food.

However, since the prior art polyolefin resin film is manufactured such that anti-bacterial material is mixed with polyolefin resin, its application except for a wrapper for food is limited.

Namely, the prior art polyolefin resin film has disadvantage in that it cannot properly protect noxious materials from the various necessaries of life. Especially, the prior art polyolefin resin film has never been applied to products, such as stationery products or necessaries for life, which have various functions, such as a thermosensitive function, a photosensitive function, and a fragrant function, etc.

### DISCLOSURE

### Technical Problem

Therefore, the present invention has been made in view of the above problems, and it is an object of the present invention to provide to a nontoxic micro anti-bacterial film coated with silver nano-particles and a method of manufacturing the same, which are capable of minimizing noxious materials from the necessaries of life.

It is another object of the present invention to provide to a nontoxic micro anti-bacterial film coated with silver nano-particles, which has an inorganic anti-bacterial characteristic which is noxious in a human body, exhales fragrance to stabilized human's body and mind, and shows various designs according to temperature and light variation, such that it can be applied to various products including the various necessaries of life.

### Technical Solution

In accordance with an aspect of the present invention, the above and other objects can be accomplished by the provision of a method of manufacturing a non-toxic micro anti-bacterial film coated with silver nano-particles comprising the steps of: producing mixed/combined powers as anti-bacterial powders, thermosensitive or photosensitive ink capsule powers, and fragrant capsule powders, and silver nano powder are combined with an additive; producing solid powders as the mixed/combined powders, and olefin, acrylic or urethane binder are mixed and then disperse; producing a paste type of print ink as the solid powders and solvent are mixed; and printing the print ink on a thin film made of olefin group resin, acrylic group resin, and urethane group resin, using a silk screen printing method, printing a predetermined design thereon.

### DESCRIPTION OF DRAWINGS

The above and other objects, features and other advantages of the present invention will be more clearly understood from the following detailed description taken in conjunction with the accompanying drawings, in which:

FIG. 1 is a schematic block diagram for describing a manufacturing process of a non-toxic micro anti-bacterial film coated with silver nano-particles according to the present invention;

FIG. 2 is a view for describing a process where a stationery product to which a non-toxic micro anti-bacterial film coated with silver nano-particles according to the present invention is transferred; and

FIG. 3 is a view illustrating a stationery product to which a non-toxic micro anti-bacterial film coated with silver nano-particles according to the present invention is transferred.

### BEST MODE

The preferred embodiment according to the present invention is described in detail below with reference to the attached drawings.

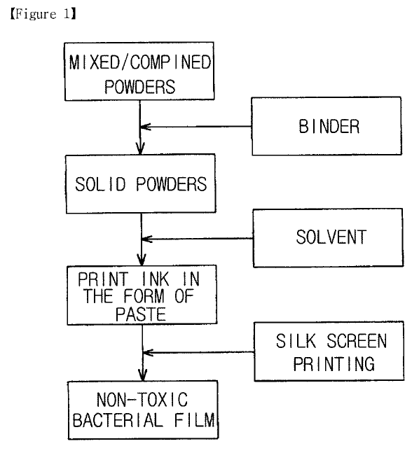

FIG. 1 is a schematic block diagram for describing a manufacturing process of a non-toxic micro anti-bacterial film coated with silver nano-particles according to the present invention.

As shown in FIG. 1, the method of manufacturing a non-toxic micro anti-bacterial film coated with silver nano-particles according to the present invention includes a step of producing mixed/combined powers as anti-bacterial powders, thermosensitive or photosensitive ink capsule powers, and fragrant capsule powders, and silver nano powder are combined with an additive.

The anti-bacterial powders serve to curb bacterial increase, and can be obtained from yellow soil, anti-bacterial zeolite or natural vegetable extracts. As long as such well-known materials are formed as powders, they can be applied to the present invention.

The fragrant capsule powders are made such that fragrant materials exhaling aroma, fruit, herb, coffee, etc., are powdered. Such fragrant materials are variously produced and sold on the market such that user can easily and arbitrarily take them.

The thermosensitive ink capsule powers is a type of ink whose color is transparent when it is over a predetermined temperature such that it cannot be identified or whose color is changed according to temperature change.

Also, photosensitive ink or luminous ink may be employed as long as they can be in the form of powders. Here, the photosensitive ink can variously show designs. Namely, the photosensitive ink has characteristics that its color is shown under the sunshine, and is transparent under the shadow. The luminous ink has characteristics that it absorbs light and emits light in the dark.

Preferably, size of respective particles of the anti-bacterial powders, theremosensitive ink capsule powders and the fragrant capsule powders is in the range of 50-300 μm. The combination ratio is as follows: 5-15 weight % of anti-bacterial powders, 45-75 weight % of thermosensitive ink capsule powders (which is identical to that of photosensitive ink powders or luminous ink powders), 15-35 weight % of fragrant capsule powders, 1-3 weight % of silver nano powders, and 2-4 weight % of additive. Here, the additive is selected from one of a surface active agent, a light and heat stabilizer and a coupler, or is combined among a surface active agent, a light and heat stabilizer.

The method of manufacturing a non-toxic micro anti-bacterial film coated with silver nano-particles according to the present invention includes a step of producing solid powders as 20-50 weight % of the mixed/combined powders, and 50-80 weight % of olefin, acrylic or urethane binder are mixed, and then dispersed.

Here, the step of dispersing the solid powers is performed such that the mixed/combined powders and the binder can be evenly dispersed. Also, in order to improve disperse property, gloss property, and adhesive property, an olefin or acrylic binder is employed, or a urethane binder is employed. Here, the olefin or acrylic binder is composed of acrylic-ester copolymer, as a primary material, and used for fiber processing, building material adhering, general coating, etc, and the urethane binder has a high disperse property for ultra-fine particles to improve adhesive property. These binders are selected based on usage of the anti-bacterial film.

Such dispersing step serves to evenly disperse various powders as machine, for example, a dissolve, operates at a rotation speed of 800-1200 rpm for 30 minute˜48 hours, thereby producing a solid powder.

The method of manufacturing a non-toxic micro anti-bacterial film coated with silver nano-particles according to the present invention includes a step of producing a paste type of print ink as 30 weight % of the solid powders and 70 weight % of solvent are mixed.

Here, the solvent is implemented with an alcohol, a petroleum light component, ether, acetone, or toluene, N-hexane, MEK, etc., which does not limit the scope of the present invention. Also, the mixing is performed by general mixing devices. After mixing, the solid powders are changed to print ink in the form of paste having a predetermined viscosity.

The method of manufacturing a non-toxic micro anti-bacterial film coated with silver nano-particles according to the present invention includes a step of printing the print ink on a thin film made of olefin group resin, acrylic group resin, and urethane group resin, using a silk screen printing method, printing a predetermined design thereon.

Here, the olefin group resin includes polyethylene, polypropylene, polysterene, polychlorovinyl, ethylene-prophylene copolymer, etc., which does not limit the scope of the present invention.

The print ink is preferably printed to have a thickness of 15-45 μm to optimize thermosensitive phenomenon of a design. The silk screen-printing method can arbitrarily adjust thickness of ink while performing printing. Therefore, the silk screen-printing method has advantage in that the printing thickness can be easily adjusted, the printed ink has a light shading force such that the printed color can be maintained without color change due to ultraviolet and infrared rays, and endurance is relatively high.

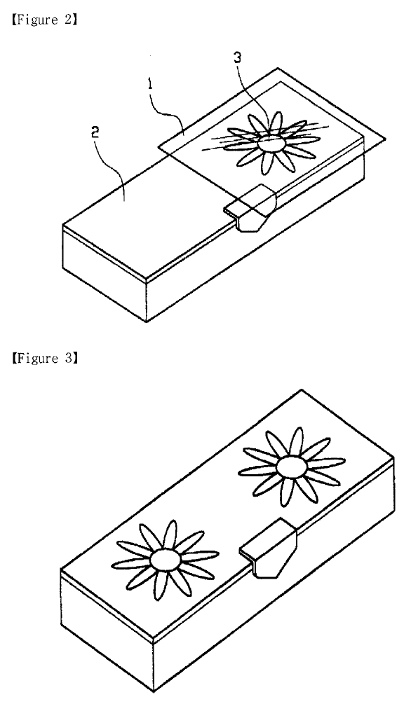

FIG. 2 is a view for describing a process where a stationery product to which a non-toxic micro anti-bacterial film coated with silver nano-particles according to the present invention is transferred. FIG. 3 is a view illustrating a stationery product to which a non-toxic micro anti-bacterial film coated with silver nano-particles according to the present invention is transferred. When the non-toxic micro anti-bacterial film 1, in which a predetermined design is printed by the above-mentioned manufacturing method, is attached on a pencil case 2, the film is putted on the pencil case 2 and pressed by a roller or a plate type of rubber roller with a predetermined pressure while heat of temperature of 90-140° C. is applied the roller. Afterwards, the design 3 is pressed and printed to the pencil case 2, and the olefin group resin film is evaporated therefrom. Therefore, the design 3 is transferred to the pencil case 2 as shown in FIG. 3.

Such transferring steps includes all steps performed by general transferring machine or by a manual work, and also can be applied too all the necessaries of life including the pencil case, which are made of synthetic resins, iron material, silicon, etc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As mentioned above, the non-toxic micro anti-bacterial film coated with silver nano-particles according to the present invention can be transferred to all the necessaries of life made of synthetic resins, iron material, silicon, etc. Also, the non-toxic micro anti-bacterial film has advantages in that the necessaries of life can be finely made as designs of the film are transferred thereto, bacterial increase can be curbed due to anti-bacterial operation such that the film is good for health, the film can induce joy and interest due to the thermosensitive or photosensitive operations, and uses can obtain refreshing and mental rest as natural fragrance are exhaled.

1. A method of manufacturing a non-toxic micro anti-bacterial film coated with silver nano-particles comprising the steps of:
producing mixed/combined powers as anti-bacterial powders, thermosensitive or photosensitive ink capsule powers, and fragrant capsule powders, and silver nano powder are combined with an additive;
producing solid powders as 20-50 weight % of the mixed/combined powders, and 50-80 weight % of olefin, acrylic or urethane binder are mixed and then disperse;
producing a paste type of print ink as 30 weight % of the solid powders and 70 weight % of solvent are mixed; and
printing the print ink on a thin film made of olefin resin, acrylic resin, and urethane resin, using a silk screen-printing method, printing a predetermined design thereon.

2. The method according to claim 1, wherein the screen printing method is performed such that the print ink can be printed to have a thickness of 15-45 μm.

3. The method according to claim 1, wherein the additive is selected from one of a surface active agent, a light and heat stabilizer and a coupler, or is combined among a surface active agent, a light and heat stabilizer.

4. The method according to claim 1, wherein the solvent is selected from an alcohol, a petroleum light component, ether, acetone, or toluene, N-hexane, MEK.

5. The method according to claim 1, wherein the thermosensitive capsule powers can be replaced with photosensitive capsule powders or luminous ink (paint) capsule powders.

6. The method according to any one of claims 1 to 4, wherein the mixed/combined powders are produced with a combination ratio as follows:
5-15 weight % of anti-bacterial powders, 45-75 weight % of thermosensitive ink capsule powders, 15-35 weight % of fragrant capsule powders, 1-3 weight % of silver nano powders, and 2-4 weight % of additive.

7. The method according to any one of claims 1 to 4, wherein respective particles of the anti-bacterial powders, theremosensitive ink capsule powders and the fragrant capsule powders have a size within the range of 50-300 μm.

8. A non-toxic micro anti-bacterial film coated with silver nano-particles comprising:
mixed/combined powers as anti-bacterial powders, thermosensitive or photosensitive ink capsule powers, and fragrant capsule powders, and silver nano powder are combined with an additive;
solid powders as 20-50 weight % of the mixed/combined powders, and 50-80 weight % of olefin, acrylic or urethane binder are mixed and then disperse;
a paste type of print ink as 30 weight % of the solid powders and 70 weight % of solvent are mixed; and
the print ink on a thin film made of olefin resin, acrylic resin, and urethane resin, using a silk screen printing method, printing a predetermined design thereon.

9. The film according to claim 8, wherein the thermosensitive capsule powers can be replaced with photosensitive capsule powders or luminous ink (paint) capsule powders.
